(19) United States
(12) Patent Application Publication
(10) Pub. No.: US 2016/0011619 A1
(43) Pub. Date: Jan. 14, 2016

(54) ENERGY MANAGEMENT SYSTEM, ENERGY MANAGEMENT METHOD, AND RECORDING MEDIUM STORING AN ENERGY MANAGEMENT PROGRAM

(71) Applicant: Kiriko CHOSOKABE, Tokyo (JP)

(72) Inventor: Kiriko CHOSOKABE, Tokyo (JP)

(73) Assignee: Ricoh Company, Ltd., Tokyo (JP)

(21) Appl. No.: 14/793,214

(22) Filed: Jul. 7, 2015

(30) Foreign Application Priority Data
Jul. 10, 2014 (JP) 2014-142332

(51) Int. Cl. G05F 1/66; G05B 13/02

(52) U.S. Cl. CPC G05F 1/66; G05B 13/026

(57) ABSTRACT

An energy management system includes a memory that stores electricity consumption amount of a target object separately for each one of a plurality of operational status of the target object, the electricity consumption amount being measured by an electricity measurement unit, and a processor that obtains information indicating the operational status of the target object for each day in the future from a calendar and predicts future electricity consumption amount for each day in the future, using the operational status of the target object for each day and the electricity consumption amount stored for each operational status.

### CROSS-REFERENCE TO RELATED APPLICATION

This patent application is based on and claims priority pursuant to 35 U.S.C. §119(a) to Japanese Patent Application No. 2014-142332, filed on Jul. 10, 2014 in the Japan Patent Office, the entire disclosure of which is hereby incorporated by reference herein.

### BACKGROUND

1. Technical Field

The present invention relates to an energy management system, an energy management method, and a non-transitory recording medium storing an energy management program.

2. Background Art

In the past, in homes and offices, it became clear how much electricity is used after receiving electric bills. However, recently, with development of an Energy Management System (EMS) technology, measurement devices are installed at users' sites, and it has become possible to know electricity usage on a day-to-day basis. With reference to the measurement results, the users can try to reduce the electricity charge by saving energy. In the EMS technology described above, a technology that predicts and reports the estimated electricity bill for the coming month based on the current electricity usage is already known. In addition, a technology that gives the users a warning after comparing the electricity usage with a target value is known.

### SUMMARY

An example embodiment of the present invention provides a novel energy management system that includes a memory that stores electricity consumption amount of a target object separately for each one of a plurality of operational status of the target object, the electricity consumption amount being measured by an electricity measurement unit, and a processor that obtains information indicating the operational status of the target object for each day in the future from a calendar and predicts future electricity consumption amount for each day in the future, using the operational status of the target object for each day and the electricity consumption amount stored for each operational status.

Further example embodiments of the present invention provide an energy management method and a non-transitory recording medium storing an energy management program.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating a system configuration as an embodiment of the present invention.

FIG. 2 is a diagram illustrating a calendar used for a configuration on a day-to-day basis as an embodiment of the present invention.

FIG. 3 is a diagram illustrating a table used for setting a reduction level on a time zone basis as an embodiment of the present invention.

FIG. 4 is a diagram illustrating a configuration of a target value in units of hour as an embodiment of the present invention.

FIG. 5 is a diagram illustrating a table for increment of a reduction level as an embodiment of the present invention.

FIG. 6 is a diagram illustrating a configuration of a target value by the hour using the table for increment of the reduction level as an embodiment of the present invention.

FIG. 7 is a result for last month as an embodiment of the present invention.

FIG. 8 is a diagram illustrating predicted electricity consumption (converted to charged amount) in case of not distinguishing operational status as an embodiment of the present invention.

FIG. 9 is a diagram illustrating predicted electricity consumption (converted to charged amount) in case of distinguishing operational status as an embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result. In figures, same symbols are assigned to same or corresponding parts, and their descriptions are simplified or omitted appropriately.

In the existing models for predicting the electricity bill based on the electricity usage amount, it is assumed that electricity is used similarly every day, and cases in which electricity usage greatly differs depending on places and time zones, such as electricity usage in offices between workdays and holidays, are not assumed, and that results in imprecise prediction. In addition, even in the same workday, electricity usage may depend on the time zones. Furthermore, while it is possible to display a predicted achievement value for a month, it becomes clear whether or not the target value is achieved only when it approaches the end of the month since the precision is improved as it approaches the end of the month. As a result, it is difficult to reduce the electricity usage as planned from the beginning of the month to achieve the target value.

In this embodiment, a novel energy management system that can precisely calculate the predicted value of the electricity bill is provided.

In the embodiment described below, assuming electricity use such as in offices, the energy management system precisely predicts the electricity usage amount, while considering usage activities that differ day-to-day (such as workdays and holidays) or time-to-time within a day (such as different time zones). The precise prediction helps a user to reduce the electricity usage as planned by setting the target value on a month-around basis.

There are three characteristics as shown below considering the day-to-day characteristics or the characteristics within a day.

1. If it is obvious that measured values in holidays behave differently from measured values on workdays, values on holidays are measured separately from normal workdays and reflected on the prediction, i.e., measured values on holidays are accumulated separately from measured values on workdays, and the measured values that are separately managed are used for the prediction.

2. After setting a target amount of electricity bill as a target value, based on actual values in the past that can be distinguished based on day-to-day characteristics, days of the months are classified into days when a user can easily reduce the electricity usage, and days when a user can hardly reduce the electricity usage. Then, calculation is performed considering days when it is easy to reduce the electricity usage and days when it is difficult to reduce the electricity usage to achieve the target value. The target value of the electricity usage amount is configured for each day.

3. Target value is configured for each time zone, after determining time zones in which electricity usage is to be reduced and time zones in which electricity usage is not to be used, within a day.

In the energy management system (power measurement/monitoring apparatus) that configures the target values for reducing electricity, factors affecting electricity demand are taken into consideration. For example, holidays and special workdays are configured in units of days and hours, and calculation is performed considering the information described above, for example, by weighing reduction amount to achieve the target electricity usage amount. As a result, it is possible to precisely predict the electricity usage amount and the target value for each time zone and each day based on the target electricity usage precisely. In addition, it is possible to keep charging power equal to or lower than a predetermined value.

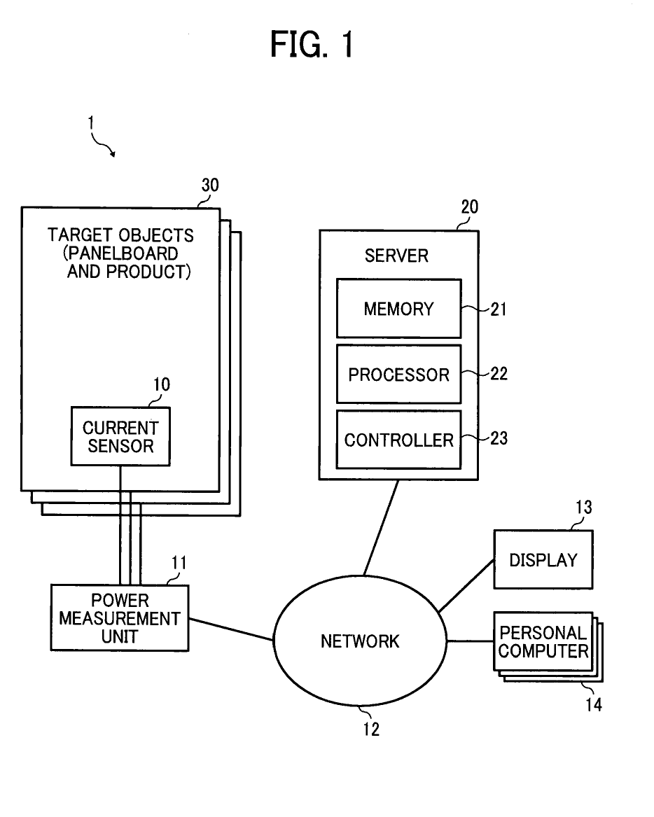

FIG. 1 is a diagram illustrating a system configuration in this embodiment. In this embodiment, an energy management system 1 installed in an office is described. A power measurement unit 11 is connected to a current sensor 10. The current sensor 10 is installed in, attached to, or connected to a target object 30, which is subject for measurement. In case of measuring the electricity usage amount of the whole office or building, switchboards and panelboards are considered as the target object. In order to measure in detail, it is possible to measure the electricity usage amount by connecting the current sensors to objects such as lightings, air-conditioners, and AC outlets etc. according to application. In addition, it is possible to measure power consumption of appliances.

The power measurement unit 11 is connected to a network 12 via a wired line or wirelessly. An example of the power measurement unit 11 is an electricity meter. A server 20 includes a memory 21, a processor 22, and a controller 23. The server 20 acquires measurement data from the power measurement unit 11 at predetermined time and stores the acquired measurement data in the memory 21. In addition, the server 20 is connected to a display apparatus 13 and a personal computer 14 via the network 12, and the server 20 calculates the measurement result and displays graphs and numeric data on a display unit of the display apparatus 13 and the personal computer 14.

The server 20 receives settings configured using the display apparatus 13 or the personal computer 14 and performs calculation and control. As a result, it is possible to control the display apparatus 13 or the personal computer 14 to output notification such as in the form of sound or display data. As shown in FIG. 1, the memory 21, calculation, display, and notification are controlled as the server functions. The measured data is picked up regularly using the power measurement unit 11. An example of the display control, the picked up data is processed so that the data can be displayed on the display unit, and information is provided regarding the data and the graph display format in response to a request from the display apparatus and the PC. It is also possible to create server-side graphic data for a graph and provide the information to the display unit. Regarding comparison control with a target value, a target value comparable with an actual data is calculated, the target value is compared with the actual value, and screen on the display unit is modified if necessary. In addition, it is possible to display notification to an administrator. Examples of the display apparatus 13 include, but not limited to, a display of a multifunction peripheral, digital signage, smartphone, and tablet devices. It is possible that the display apparatus 13 is integrated into the server 20.

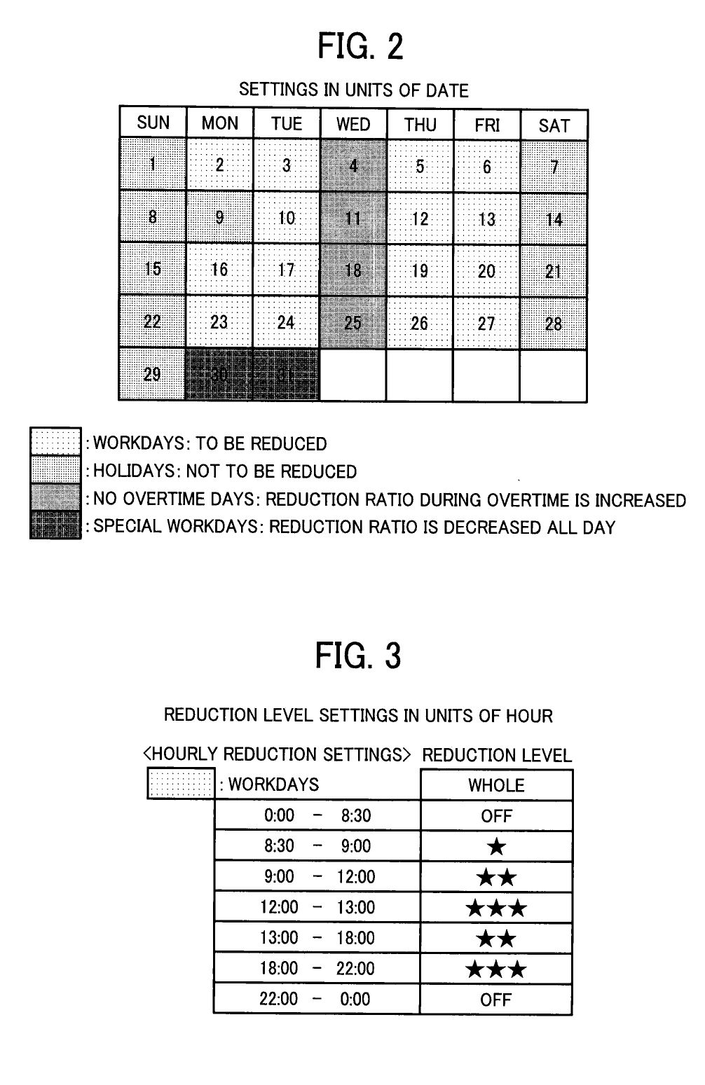

The server 20 is a main component of the energy management system 1. The server 20 can be referred to as a power measurement/monitoring apparatus. The memory 21 stores power consumption amount measured by the power measurement unit 11 that measures power consumption amount of the target object 30. Here, the memory 21 stores the power consumption amount by operational status of the target object 30. Here, in this embodiment, four types of “the operational status”, are used including working days when overtime is not recommended (herein after referred to as “no overtime days”), normal workdays, special workdays, and holidays, as described later in detail with reference to FIG. 2.

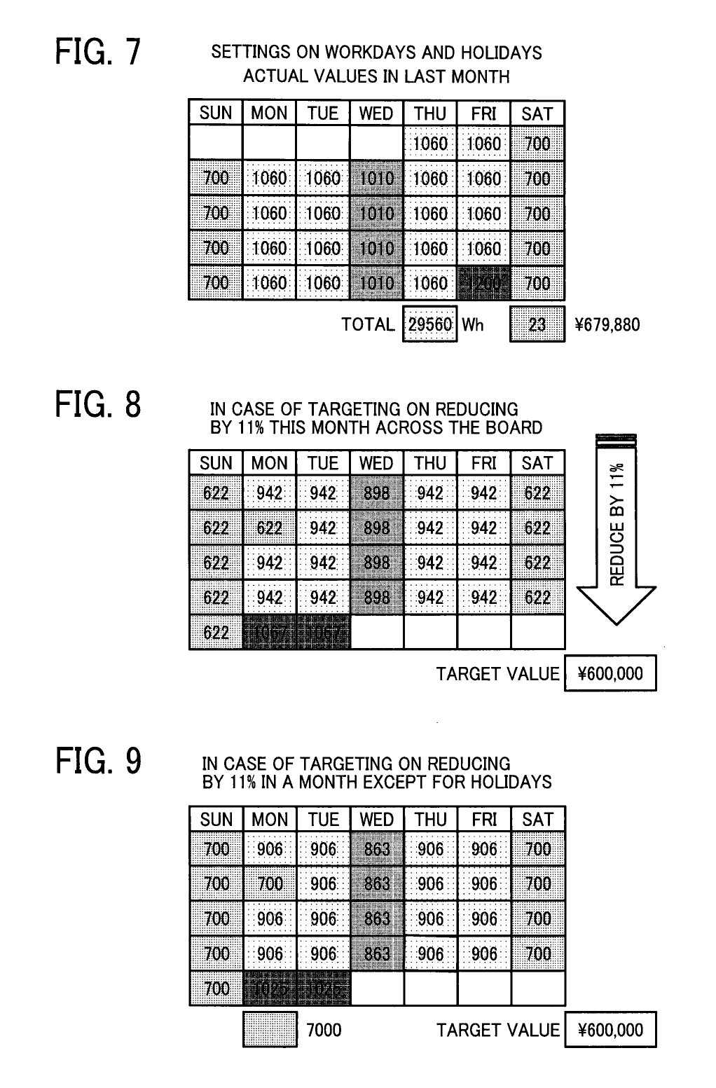

The processor 22 performs various calculations, especially calculation that predicts future power consumption amount of the target object 30. In this prediction, the calculation is performed based on a calendar (with reference to FIG. 2) that includes information on the day-to-day operational status of the target object 30. The processor 22 predicts the power consumption amount for each day based on the past power consumption amount stored in the memory 21 for each operational status as shown in FIG. 7. The power consumption amount on one day is predicted based on the past power consumption amount around the same day in the past and the same operational status as the operational status scheduled on that day. For example, it is possible to predefine four types of configuration by user operation in accordance with the operational statuses as described below. In accordance with the categorization, it is predicted that the future power consumption amount is approximately equal to the past power consumption amount in the same categorized operational status in the past. Regarding the same categorized operational status in the past, it is possible to use a daily average value during a certain period or data in a specific day. For example, in case of assuming that June 26 is defined as “a working day”, it is possible to predict the power consumption amount on June 26 using an average value of the power consumption amount on “working days” from May 26 to June 26 in the past. In addition, other than using the operational status, it is possible to use weather conditions that affect the power consumption amount (e.g., the highest temperature or amount of sunlight etc.) as a classification condition.

FIG. 2 is a diagram illustrating a calendar used for a configuration on a day-to-day basis in this embodiment. The server 20 can configure characteristic for each day on a day-to-day basis. For example, there are four types of configuration, working days, holidays, no overtime days, and special working days. The special working day may be, for example, a day in which a company asks employees to work irrespective of whether that day is a holiday or not.

On working days, the electricity usage amount fluctuates substantially, and the electricity usage is to be reduced in case of lowering the electricity bill. On holidays, differently from the working days, the electricity usage amount remains constant, the electricity usage amount cannot be reduced anymore, and the electricity usage is not to be reduced in case of lowering the electricity bill. On no overtime days, differently from the normal workdays, high reduction rate is set to a certain time zone, i.e., overtime time zone to reduce the electricity usage during that time zone. On special working days, it is prioritized to perform operation rather than to reduce electricity usage for a whole day, and a lower target value is set to reduce the electricity usage.

As described above, days are categorized in accordance with their characteristics, that is, activities that can be predicted to be performed, and the actual measurement results are accumulated for each category. As a result, it is possible to grab tendency precisely exploiting their characteristics. These settings are configured on the personal computer 14 and the display apparatus 13, and the server 20 uses them for the calculation via the network 12. In this embodiment, one month starts from 1st and ends on 31st for convenience of explanation. However, in determining the target value of the electricity bill for a month, one month is displayed and calculated in accordance with the meter reading day or the electric power company's cutoff day.

Furthermore, in this embodiment, reduction levels are configured for each time zone within one day. FIG. 3 is a diagram illustrating a table used for a configuration of reduction levels on a time zone basis in this embodiment. The server 20 can configure reduction levels for each time zone within the day configured in units of a day in FIG. 2 using the table in FIG. 3. In FIG. 3, one day is divided into seven time zones.

For example, in the time zone from 0:00 to 8:30, since the electricity usage amount is constant and cannot not be reduced anymore, the reduction level is not configured (in this case, the reduction level is set to “off”). After that, in the time zone from 8:30 to 9:00, the employees are arriving at the office, and electricity usage increases gradually. However, since it is difficult to reduce the electricity usage in this time zone, the reduction level is set to 1 (in this case, one star symbol indicates 1). After that, except the lunch time zone from 12:00 to 13:00, in the working hour time zones, the electricity is consumed largely by air-conditioners, lightings, and AC outlets etc. Therefore, it is possible to reduce the electricity use in these time zones (in this case, two stars indicate the reduction levels 2). In the lunch time zone, since the lightings in offices are turned off, the reduction level is set to a higher value (in this case, three stars indicate the reduction level 3). In the overtime time zone from 18:00 to 22:00, the reduction level is set to a higher value too. In the time zone from 22:00 to 0:00, since the electricity usage amount is constant, the electricity usage is not reduced (in this case, the reduction level is set to “off”). As described above, time slots are configured in units of thirty minutes, and the reduction levels are set to each time zone. On another configuration screen, numeric values with a certain range, only the lower limit value, or the reduction rate for one star are set to the reduction levels (for example, one star indicates that the reduction rate is 10% at a maximum, two stars indicate that the reduction rate is 20% at a maximum, and three starts indicate that the reduction rate is 30% at a maximum).

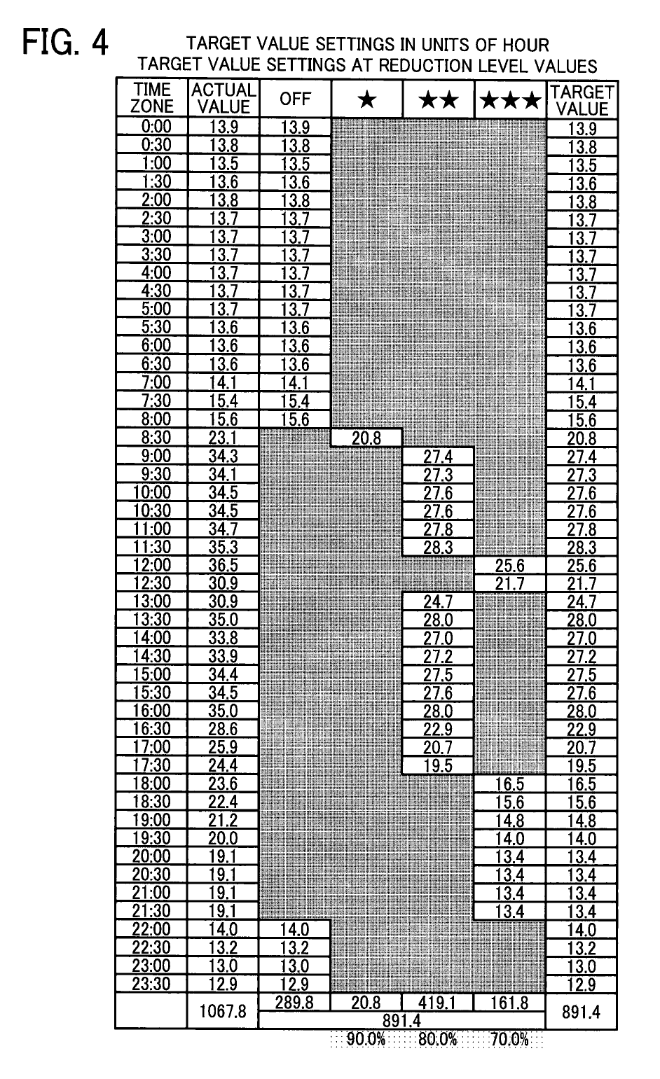

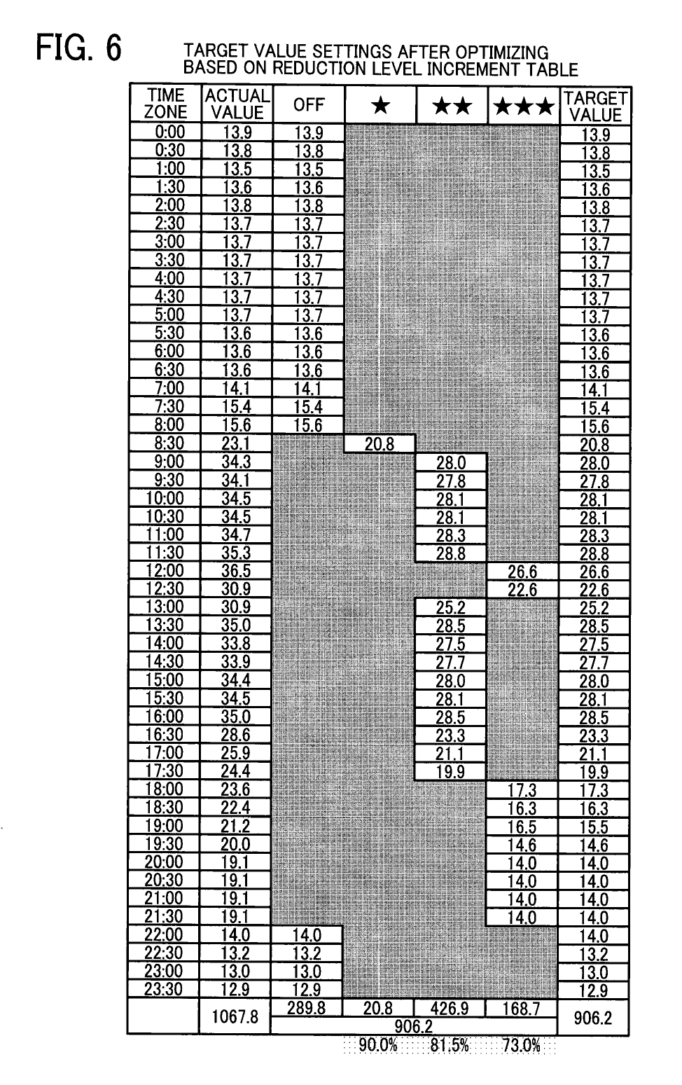

Furthermore, in this embodiment, the processor 22 configures the target value of the electric consumption amount in accordance with the reduction levels configured for each time zone. In this case, the processor 22 calculates the upper limit value of the electric consumption amount in units of hour that relates to a base rate contracted with the electric power company. FIGS. 4 and 6 are diagrams illustrating configurations of target values in units of hour in this embodiment. In FIGS. 4 and 6, the unit of time that relates to the base rate contracted with the electric power company is thirty minutes.

FIG. 4 is a diagram illustrating a configuration of target values in reduction level values in this embodiment. The processor 22 configures the reduction amounts as shown in FIG. 4 based on the level settings for each time zone in FIG. 3. In FIG. 4, columns indicate time zones, actual values, four levels of the reduction levels (i.e., off, one star, two stars, and three stars), and target values from left to right. The time zones indicate time in units of thirty minutes. The actual values reflect past actual measured values of electricity usage amount in units of thirty minutes from the time in the time zones. In the next four columns, reduction levels are configured for each reduction level as shown in FIG. 3, and configured target values are indicated after practicing those values. Outside the table, their reduction level values are indicated in units of percent.

For example, assuming the target value of the electricity consumption amount for the day as the value reducing 15% of the actual value, the target value can be calculated by the processor 22 using the equation below.

Target value: 1067.8*(1−0.15)=906.95

In addition, the target value satisfies the equation below.

Target value≧(total in OFF time zones)+(total in one star time zones)*(reduction level of one star)+(total in two stars time zones)*(reduction level of two stars)+(total in three stars time zones)*(reduction level of three stars)

An example of the reduction level that satisfies the second equation with reference to FIG. 4 is shown below.

906.95≧289.8+23.1*0.9+523.8*0.8+231.1*0.7=891.4

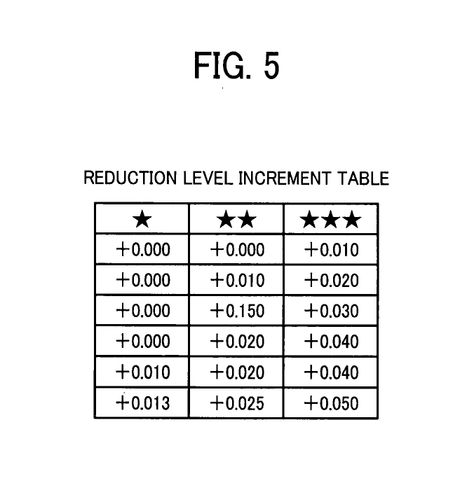

FIG. 5 is a diagram illustrating a table for increment of reduction levels in this embodiment. In the configuration shown in FIG. 4, the reduction level values become too large, and it is difficult to satisfy the reduction rates compared to the total target value. Therefore, in this embodiment, furthermore, the reduction rates are not lowered too much, and the reduction rates are adjusted to achieve the target values. To cope with the issue, regarding the configured reduction levels, the reduction levels increase gradually in accordance with the table in FIG. 5 so that the reduction levels become values just before exceeding the target values, and the most appropriate reduction levels and target values are calculated. In the table shown in FIG. 5, as the reduction levels get strict, the increasing levels of reduction get higher. In addition, it is possible that those numerical values are configured by user operation.

FIG. 6 is a diagram illustrating a configuration of target values adjusted based on the table for increment of the reduction level in this embodiment. In FIG. 6, the target values are increased in accordance with the table in FIG. 5 to achieve just 15% as the target value. The colored part at the bottom of the table indicates the optimized reduction levels.

Furthermore, in this embodiment, it is possible to describe the target value of the electric consumption amount configuring the reduction level by using the predicted bill to be charged. In that case, an example case is shown in FIGS. 7 to 9. In FIGS. 7 to 9, the case is described in units of day.

An effect in this embodiment is described below with reference to FIGS. 7 to 9. That is, the difference between the configured target values depending on configurations of workdays and holidays is described below. FIG. 7 is a result for last month in this embodiment. In FIG. 7, the result for last month and the charged amount of the electricity bill (e.g., 679,880 yen charged from the beginning of the month to the end of the month for convenience of explanation). Numeric values in each cell indicate the electricity usage amount for that day.

FIG. 8 is a diagram illustrating predicted electricity consumption (converted to charged amount) in case of not distinguishing operational status in this embodiment. In FIG. 8, it is targeted to reduce 11% in this month across the board. In FIG. 8, the reduction rate is set to 11% in all days across the board assuming the constant charged amount of the electricity bill (60,000 yen after reducing 11%). In this case, it is difficult to achieve the target for holidays.

FIG. 9 is a diagram illustrating predicted electricity consumption (converted to charged amount) in case of distinguishing operational status in this embodiment. In FIG. 9, it is targeted to reduce 11% except holidays in this month. Since the electricity usage seldom fluctuates in holidays and it is difficult to reduce the electricity usage even in case of targeting to reduce a certain amount across the board, to achieve the reduction target for the whole month, the electricity usage amount is configured to achieve reduction of 11% with workdays only. In this case, it is relatively easy to achieve the target regardless of the operational status. As a result, it is possible to calculate the target value of the electricity consumption bill more precisely.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor. A processing circuit also includes devices such as an application specific integrated circuit (ASIC) and conventional circuit components arranged to perform the recited functions.

What is claimed is:

1. An energy management system, comprising:
a memory to store electricity consumption amount of a target object separately for each one of a plurality of operational status of the target object, the electricity consumption amount being measured by an electricity measurement unit; and
a processor to obtain information indicating the operational status of the target object for each day in the future from a calendar, and
predict future electricity consumption amount for each day in the future, using the operational status of the target object for each day and the electricity consumption amount stored for each operational status.

2. The energy management system according to claim 1, wherein the processor predicts electricity bill in units of day based on the predicted electricity consumption amount and electricity bill previously charged in units of month.

3. The energy management system according to claim 2, wherein the processor calculates a reduction target of the electricity consumption amount in units of day.

4. The energy management system according to claim 3, wherein the processor calculates a reduction target of the electricity consumption amount for each time zone within a day based on the calculated reduction target of the electricity consumption amount in units of day.

5. The energy management system according to claim 4, wherein the processor calculates an upper limit value of the electricity consumption amount in units of hour based on the calculated reduction target of the electricity consumption amount for each time zone, the units of hour being defined by a base rate set by an electric company.

6. The energy management system according to claim 3, wherein the operational statuses include workdays when overtime is not recommended, normal workdays, special workdays, and holidays, and the reduction targets of the electricity consumption amount in units of day are configured, respectively, for the operational statuses in the descending order, the workdays when overtime is not recommended, the normal workdays, the special workdays, and the holidays

7. An energy management method, comprising:
storing electricity consumption amount of a target object separately for each one of a plurality of operational status of the target object, the electricity consumption amount being measured by an electricity measurement unit;
obtaining information indicating the operational status of the target object for each day in the future from a calendar; and
predicting future electricity consumption amount for each day in the future, using the operational status of the target object for each day and the electricity consumption amount stored for each operational status.

8. A non-transitory, computer-readable recording medium storing a program that, when executed by a processor, causes the processor to implement an energy management method, the method comprising the steps of:
storing electricity consumption amount of a target object separately for each one of a plurality of operational status of the target object, the electricity consumption amount being measured by an electricity measurement unit;
obtaining information indicating the operational status of the target object for each day in the future from a calendar; and
predicting future electricity consumption amount for each day in the future, using the operational status of the target object for each day and the electricity consumption amount stored for each operational status.
